(19) United States
(12) Patent Application Publication
(10) Pub. No.: US 2015/0280769 A1
(43) Pub. Date: Oct. 1, 2015

(54) CASE FOR A MOBILE COMMUNICATIONS DEVICE

(71) Applicant: SATcase Ltd., Didcot (GB)

(72) Inventor: James L. Thomson, Didcot (GB)

(21) Appl. No.: 14/435,883

(22) PCT Filed: Oct. 16, 2013
(86) PCT No.: PCT/GB2013/000437

§ 371 Date: Apr. 15, 2015

(30) Foreign Application Priority Data
Oct. 16, 2012 (GB) 1218573.2

(51) Int. Cl. H04B 1/3888; H04M 1/02

(52) U.S. Cl. CPC H04B 1/3888; H04M 1/0202

(57) ABSTRACT

The present invention relates to a case for releasably securing a mobile communications device in a sealed environment. The case is adapted to enable the device to operate with mobile, wireless, cellular and satellite communications.

The present invention relates to a case for releasably securing a mobile communications device in a sealed environment. In particular, the present invention relates to a case for releasably securing a mobile communications device in a sealed environment, in which the case is adapted to enable the device to emit an emergency response signal, for example a radio response signal. Furthermore, the present invention relates to a case for releasably securing a mobile communications device in a sealed environment, in which the case is adapted to enable the device to operate with dual global communications, for example cellular and satellite communications.

### BACKGROUND OF THE INVENTION

In order to stay safe and to be able to request an emergency response whilst being active in remote locations, such as for example in the air or out at sea where cellular communications are not available, a user is currently required to carry multiple devices, each device being capable of performing a separate function. Furthermore, whilst carrying a mobile communications device during an activity the device may become exposed to harsh external conditions, for example rain, which may be detrimental to the device.

Examples of devices for requesting an emergency response include:
Stand-alone satellite phones, such as for example an Iridium Extreme™ satellite phone. Satellite phones are however unable to utilise cellular connectivity for receiving or transmitting signals;
Combined GSM/Satellite portable devices, such as for example Terrastar GENUS and Thuraya XT-DUAL™, provide options for dual connectivity;
Track and Trace modules and devices, such as for example Globalstar FIND-ME-SPOT™. These modules and devices are limited by range and functionality and have no or limited ability to receive and transmit voice signals;
Personal Location Beacons (PLB) Rescue radios, such as for example BECKER Avionics ML510. These are however typically only used by the military; and
Emergency Location Transmitter (ELT) emergency location signalling devices such as for example KANNAD 406 AF-Compact. These devices are required to be permanently fixed to a vehicle, vessel or aircraft.

One disadvantage of the known devices is that an individual must carry multiple devices with them or in the case of, for example, rescue beacons have them permanently affixed to a vehicle, vessel or aircraft that the user is travelling in. The user may however leave the vehicle during their activity and therefore the device is abandoned.

A disadvantage of using a stand-alone satellite phone or combined cellular/satellite phone, is that the user must first transfer all of their contacts from their mobile communications device, such as for example a smart device, to the satellite phone in order to provide a separate contacts list. The user may then abandon their smart device and its other applications.

Track and Trace satellite devices are limited to short burst data (SBD) of GPS location only and rely solely on the owner maintaining a subscription with a monitoring service or friends and family being contacted in the event of an emergency.

The present invention seeks to address one or more of the disadvantages associated with the known devices. In particular, the present invention seeks to provide a case which is arranged to provide a secure protective environment, for example sealed to the elements, around a mobile communications device. Furthermore, the present invention seeks to provide a case which is arranged to enable a device to operate with dual global communications, for example cellular and satellite communications.

### SUMMARY OF THE INVENTION

According to a first aspect, the present invention provides a case for releasably securing a mobile communications device in a sealed environment, in which the case is adapted to enable the device to operate with communications selected from mobile, wireless, cellular and satellite communications.

The present invention provides an active, intelligent, rugged, secure case which is sealed to the elements. The case preferably comprises independent power sources. The case enables the user to transport various mobile communications devices, such as for example smart devices. The case provides a sealed environment around the mobile communications device so as to protect the device from the external environment which may affect the ability of the device to operate. The case is arranged to extend the functions, service and range into remote locations of the device.

The case enables the user to dispense with the need to carry multiple devices in order to be able to emit an emergency response signal in remote areas where cellular communications may not be available. Furthermore, the case enables the user to continue to use the existing mobile communications device with its full functionality and stored personal data. The case provides seemless and effective dual global communications.

The case preferably comprises:
a connector coupled to a source of electrical power, in which the connector is arranged in use to be connected to the mobile communications device; and
a satellite modem arranged in use to be operable by the mobile communications device.

The case preferably comprises three main components:
a hardware component;
an electronics package installed in a rugged, secure case; and
a software application installed on the device to activate the case.

Hardware Component

The case may be constructed from any suitable materials, such as for example injection moulded plastic. The case may include at least one transparent plastic membrane which is arranged in use to be located adjacent the mobile communications device so as to allow the device to be operated, for example to enable input to the device. The device is preferably operated by the user touching the transparent plastic membrane which is in communication with the device. The transparent membrane may be affixed to the case by any suitable means, such as for example by using an industrial adhesive.

The case preferably provides a cavity shaped and dimensioned to receive the mobile communications device. The case may be moveable between an open configuration providing an opening into a cavity for receiving a mobile communications device, and a closed configuration providing a sealed environment around the cavity for receiving the mobile communications device.

The case may comprise an upper portion and a lower portion which are arranged to releasably engage each other. The upper portion and the lower portion may be arranged to provide a cavity shaped and dimensioned to receive the mobile communications device. The upper portion and the lower portion may be arranged to be moveable between an open configuration in which at least a portion of the upper and lower portions are disengaged so as to provide an opening into the cavity for receiving the communications device; and a closed configuration in which the upper and lower portions sealingly engage to provide a protective, sealed environment around the cavity for receiving the communications device.

The upper portion of the case may include at least one transparent plastic membrane which is arranged in use to be located adjacent the mobile communications device so as to allow the device to be operated, for example to enable input to the device. The transparent plastic membrane may be affixed to the upper portion by any suitable means, such as for example by an industrial adhesive.

The upper and lower portions may be hingeably connected. For example, each of the upper and lower portions may comprise at least one, preferably a plurality of hinges to secure the upper and lower portions together. The upper and lower portions may be secured together by several methods, eg. metal pins through the hinge and the lower portion and the same for the upper portion. The upper and lower portions may be slideably engaged.

The case may further comprise a locking mechanism for retaining the case in the closed position. The locking mechanism may comprise any suitable locking member(s), for example hinged clips or hooks. Hinged clips may be made from either high strength plastic or metal. The number of locking members, the design, the material used and the method of fastening may vary depending on the size of the case and other factors which are necessary in order to provide a protective seal.

The case may further comprise a seal, for example a gasket. The seal may be arranged in the closed position to provide a sealed environment around the cavity for receiving the mobile communications device to prevent the ingress of dust and/or moisture. The seal may be composed of any suitable material, such as for example flexible silicon and/or rubber material. Preferably, the seal is located within the case in the desired location without requiring any additional mechanical fixing or adhesive to retain the seal in position.

The seal may be arranged to be located between the upper and lower portions of the case when in the closed position. The seal may be arranged such that when the upper and lower portions are in the closed position, the case provides a sealed environment around the cavity for the mobile communications device. The seal may be connected to one or more of the upper and lower portions of the case.

The upper portion preferably comprises an engagement surface arranged to releasably engage a corresponding engagement surface provided by the lower portion and/or a seal. The engagement surfaces may provide complementary engagement features for providing a seal between the upper and lower portions of the case. At least one engagement surface of the upper and lower portions may provide at least one raised ridge. The engagement surface provided by the other portion may provide at least one complementary shaped recess for receiving the raised ridge(s).

The at least one raised ridge is preferably arranged to engage a seal located between the engagement surfaces of the upper and lower portions of the case in the closed configuration to provide the sealed protective environment. For example, the inside edge of the engagement surface of the upper portion may provide a raised ridge which is arranged in use to be forced against the seal, and when closed with the lower portion the whole case is kept closed tightly by for example hinged clips to make a secure seal against the elements.

The case may further comprise a device tray shaped and dimensioned to receive and/or align the mobile communications device in the desired location within the case. Preferably, the device tray is located so as to align the mobile communications device with the transparent plastic membrane of the case. The device tray may be constructed from various materials, such as for example injection moulded plastic. The device tray is preferably located within the cavity provided by the case so as to position the device against an electronic connector. The device tray is preferably located so as to position the device against an electronic connector when the case is in the closed configuration.

The case may further comprise an emergency button operable to cause the mobile communications device to emit an emergency response signal, for example a radio response signal. The emergency button may be located within the cavity provided by the case. The emergency button may also be in communication with the device tray located within the case. The device tray may for example provide at least one opening or recess for receiving at least a portion of the emergency button.

The emergency button may be constructed from any suitable material, such as for example silicon and/or rubber material. The emergency button may be arranged so as to provide a dust and water seal around the case. The emergency button is preferably installed within the case so that no mechanical fixings or adhesive are required to keep it in place.

The case may further comprise an emergency button cover in communication with the emergency button. The emergency button cover may be located so as to prevent accidental operation of the emergency button. The emergency button cover may be constructed of either metal or plastic material. The emergency button cover may be designed in such a way so as to be clipped into the case device tray without any mechanical fixing. The case may further comprise an emergency button spring. The emergency button spring may be assembled with the emergency button cover. The emergency button cover may be resiliently biased by the spring so as to hold the cover closed until the cover is removed or opened. Once the emergency button cover has been removed, the emergency button may be operated by the user. The emergency button is preferably integrated with a rescue radio. The emergency button may be connected to for example a rescue radio beacon.

The case may also include an “in case of emergency sticker” positioned to cover the emergency button cover. The sticker may be composed of plastic. The sticker may be water resistant, self adhesive and tamper proof. The sticker may include a message such as for example “in case of emergency”; “pull here” and/or “void when removed”.

The case may further comprise at least one transparent end cap. The end cap may be composed of any suitable material, such as for example injection moulded plastic. The at least one end cap is preferably arranged so as to cover and provide a sealed environment around at least a portion of the case. For example the end cap is preferably arranged so as to cover and provide a sealed environment around at least part of the electronics package, for examples around a module of LED lights. The case may further provide a sealable hole shaped and dimensioned to receive a standard audio/microphone plug. The sealable hole may for example be provided by the transparent end cap.

The case may further include an attachment feature for engaging for example a lanyard.

The case may further comprise a power socket protection seal. The power socket protection seal may be a removable plug shaped and dimensioned to seal the connector and/or the recharging power jack of the electronics package against the dust and/or moisture in the external environment. The seal may be composed of any suitable material, such as for example flexible silicon and/or rubber material. The seal is arranged to be received within and to seal the power socket without requiring any additional mechanical fixings or adhesive to retain the seal in position.

Electronics Package

The case may further comprise an electronics package comprising at least one electronic component. The at least one electronic component may contain a number of core component modules and/or off the shelf electronics hardware to integrate the electronics component with plugs, sockets and/or rechargeable battery packs. The electronics package may for example comprise a module of LED lights. The electronics package is preferably connected to the connector.

The electronics package may be located at any suitable position within the case. Preferably, the electronics package is located within the lower portion of the case.

A number of core electronics modules and components are required to be assembled by a competent electronics engineer onto a circuit board where some components are surface mounted and may require specialist tools and skills for assembly and integration with various off-the-shelf components as required.

A number of core electronic modules and components may be provided within the case. The case may for example comprise one or more of the following:
Logic module: a number of integrated standard components used to manage electronic voltages and power requirements throughout the circuits;
Open accessory module: an integrated circuit such as the FT311D-32L manufactured by FTD, to enable the connection of an Android based device such as a smartphone or smartPad to another device such as our electronics package, via a USB wired connection allowing for bi-directional communication between the devices;
LED module: a package including off-the-shelf LEDs used for illumination and integrated into the circuit in such a way that they can remain static or blink/flash at various rates on demand when initiated by rescue radio circuitry;
Satellite modern module: a module, for example an Iridium 9523 modem, which can transmit and receive voice, video, data and short burst data (SBD) as well as providing GPS location information via for example the Iridium satellite network. The modem is integrated into the circuit in such a way that these functions can be used in their various modes. The modem may be connected via a son coaxial cable to an antenna to support the transmit/receive functions;
SIM card module: An example includes the Amphenol C70710M0065002. This module may be integrated into the circuit as required to enable the Satellite modem module's, for example an Iridium modem's, various modes;
Rescue radio module: a VHF/UHF transmit/receive integrated circuit able to transmit/receive on at least one emergency radio frequency, such as for example 121.5, 156.8, 243 and 406 Mhz. The module may be connected to an antenna via a 50Ω coaxial cable. The rescue radio module may be in communication with, for example integrated with, the emergency button;
VHF/UHF antenna: The antenna is preferably arranged to enable the transmit/receive functions on at least one emergency radio frequency, such as for example 121.5, 156.8, 243 and 406 Mhz for the rescue radio module;
Battery power source: may be any suitable source such as for example a lithium-ion battery, or other suitable re-chargeable battery. Preferably the battery source is capable of producing between 3.3 and 5.5 Volts in order to power the circuit and its various modules. The power source is preferably capable of being recharged via an external power source using a standard connector;
External power connector: This may be either a Centre Pin Power Socket with recharging power supplied by a suitable mains charger or a Micro/Min USB type socket providing power via a USB cable from a personal computer, laptop or other USB power source;
Satellite antenna: designed to enable the transmit/receive functions of the satellite modem module, for the TDMA/FDMA multi-plexing method, TDD Duplexing Method, in the frequency range of 1616-1626.5 MHz with an impedance of 50Ω;
USB/OTG connection: For example, a USB-A/B Male type plug. The plug may be integrated into the circuit for connection by the USB-A/B Female type socket in the stand alone mobile communications device, for example smart device;
Audio connector: The audio connector may be integrated with the Satellite modem module and the USB/OTG connection so as to provide audio output through to the mobile communications device and an external audio jack which may for example be housed within a transparent end cap.

Software Component

In order for the mobile communications device to be able to be used with the case of the present invention, an android application may be required to be downloaded to the device. Preferably, the case is arranged such that once the device is received within and connected to the case the android application is automatically downloaded to the device. A link to the application may be embedded in the open accessory module. The android application preferably uses standard API's available to a developer via Google Android Software Development Kit (SDK) and are related to USB/Serial Communications and the Google Android Open Accessory Development Kit (ADK).

The main features of the android application are:
to enable the mobile communications device to switch over to satellite communications when out of range of cellular communications; and
to enable the mobile communications device to be used to activate the rescue radio communications and emergency features.

Suitable mobile communication devices, such as for example smart devices, for use with the case of the present invention include devices using the Android™ operating system version 2.4 with a Kernel of 2.6.32 and having a USB/Serial interface with full OTG support enabled. For example, the SAMSUNG Galaxy S3™ smartphone with the Google Android 4.04 operating system and Kernel 3.9.15 which has not been ROOTed.

### BRIEF DESCRIPTION OF THE DRAWINGS

Embodiments of the invention will now be described, by way of example only, and with reference to the accompanying drawings, in which:

FIG. 1 illustrates a schematic illustration of the electronics package of the case according to one embodiment of the present invention;

FIG. 2 illustrates a schematic illustration of the case according to one embodiment of the present invention in the closed configuration;

FIG. 3 illustrates a schematic illustration of the case of FIG. 2 in the open configuration;

FIG. 4 illustrates schematic illustrations of side views and end views of the case of FIG. 2 in the open and closed configurations;

FIG. 5 illustrates an exploded view of the case of FIG. 2; and

FIG. 6 illustrates a plan view of the electronics package of the case according to one embodiment of the present invention.

### DETAILED DESCRIPTION OF THE INVENTION

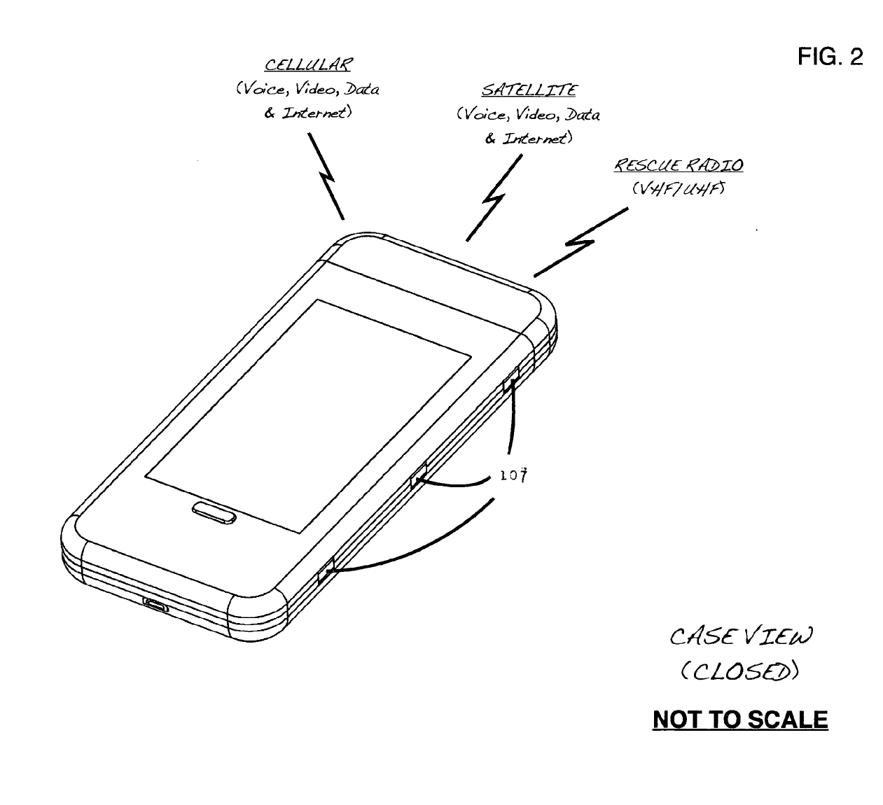

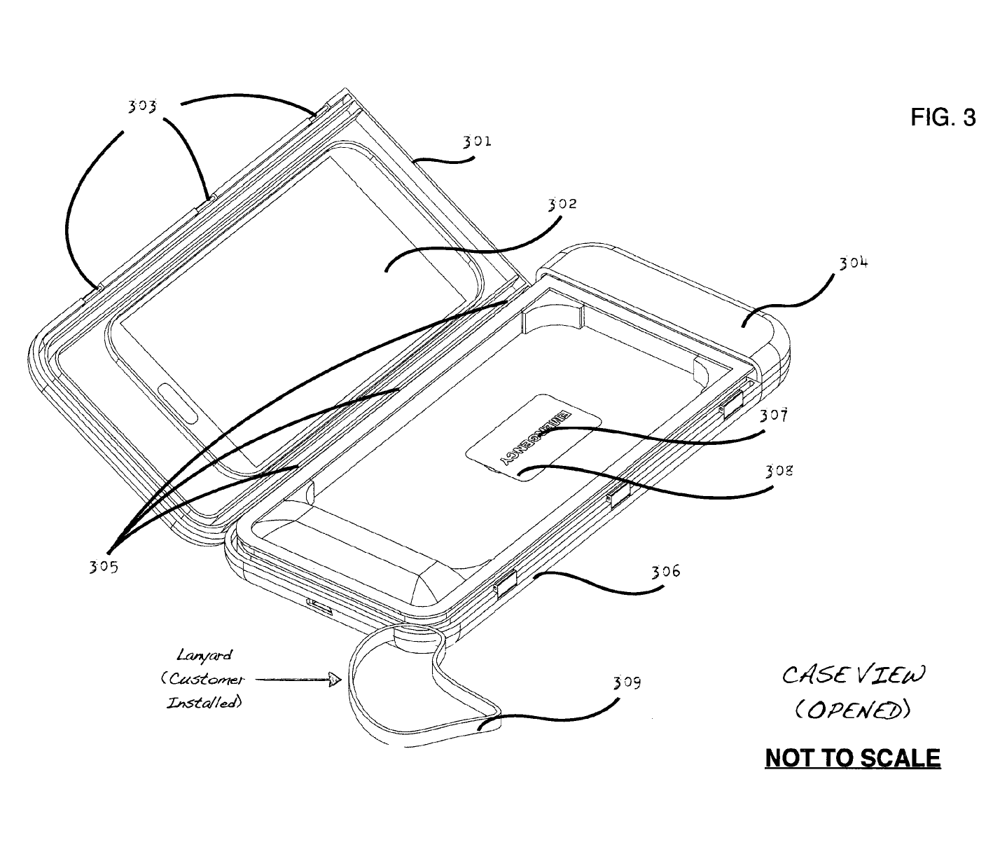

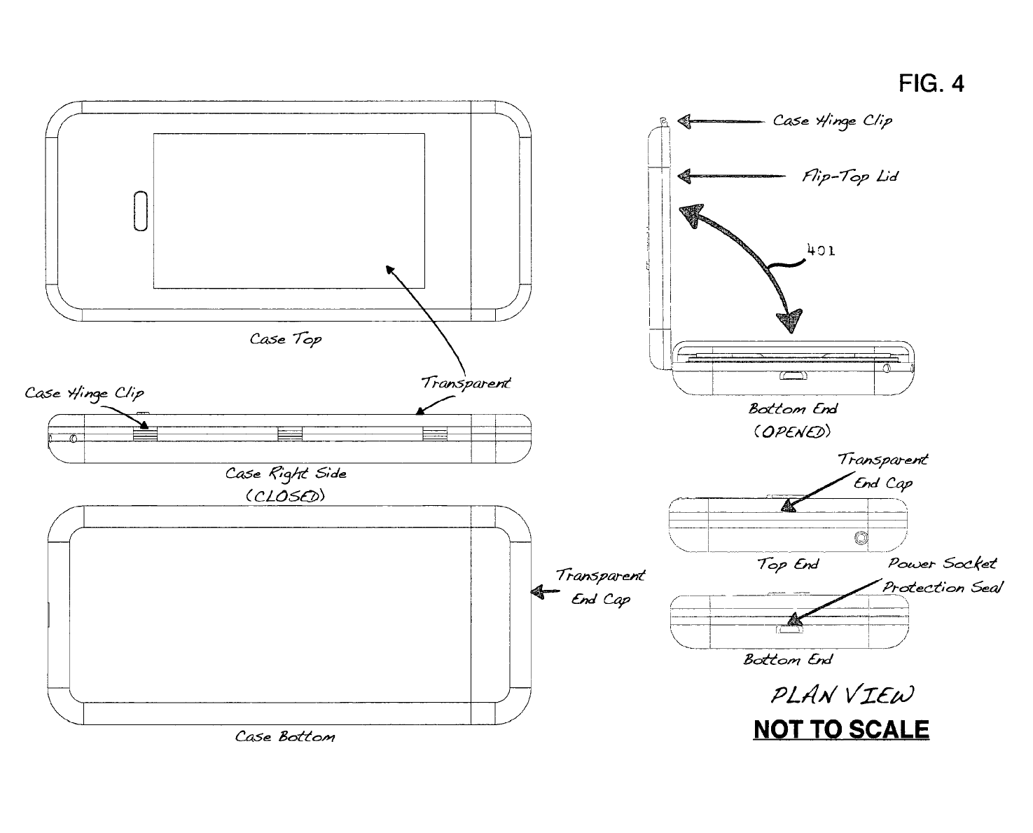

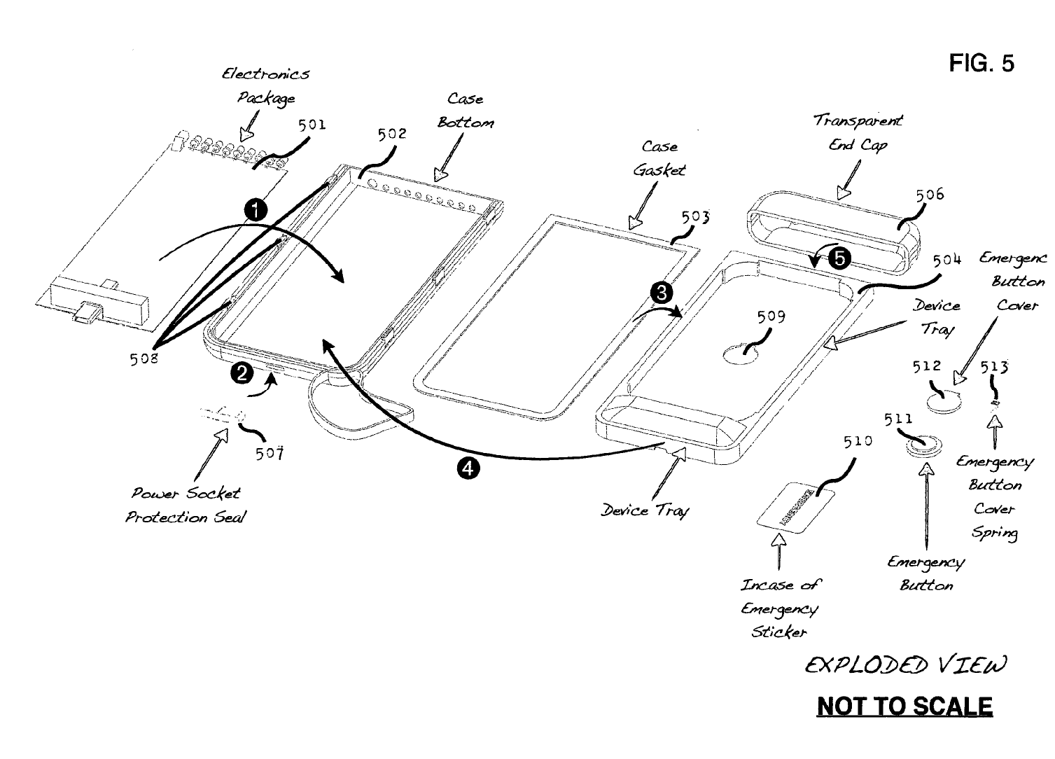

With reference to FIGS. 2 to 5, the case 1 is substantially rectangular in shape. The case 1 provides a cavity 4 shaped and dimensioned to receive a mobile communications device (not shown), such as for example a smart phone. The case 1 comprises an upper portion 2 and a lower portion 3 hingeably connected by four hinges 6 located along first side portions 7,7′ of the upper portion 2 and lower portion 3 of the case 1. The upper portion 2 and lower portion 3 are arranged to releasably engage each other. The upper portion 2 and the lower portion 3 are moveable between an open configuration (FIGS. 3 and 4) in which at least a portion of the upper 2 and lower 3 portions are disengaged so as to provide an opening into the cavity 4 for receiving the communications device; and a closed configuration (FIGS. 2 and 4) in which the upper 2 and lower 3 portions sealingly engage to provide a protective, sealed environment around the cavity 4 for receiving the communications device.

The upper portion 2 of the case 1 includes a transparent plastic membrane 5 which is arranged in use to be located adjacent the mobile communications device when retained within cavity 4 so as to allow the device to be operated, for example to enable input to the device. The transparent plastic membrane 5 is substantially rectangular in shape.

The case 1 further comprises four spaced apart hinged clips 8 located on a second side portion 9 of the upper portion 2 of the case 1. The hinged clips 8 are arranged to releasably engage the second side portion 10 of the lower portion 3 of the case 1 in order to retain the case 1 in the closed position.

Although the embodiments illustrated in the figures show the use of hinged clips it is to be understood that the case may include any suitable locking member(s) for retaining the upper and lower portions in the closed position. The number of locking members, the design, the material used and the method of fastening may also vary depending on the size of the case and other factors which are necessary in order to provide a protective seal.

The case 1 further comprises a seal 11. The seal 11 may be composed of any suitable material, such as for example flexible silicon and/or rubber material. The seal 11 is located between the upper 2 and lower 3 portions of the case 1 when in the closed position. When in the closed position, the seal 11 provides a sealed environment around the cavity 4 for the mobile communications device. The seal 11 is shaped so that in the closed position the seal 11 substantially surrounds the perimeters of the upper 2 and lower 3 portions of the case 1.

The case 1 further comprises a device tray 12 shaped and dimensioned to receive and/or align the mobile communications device within the case 1. The device tray 12 is substantially rectangular in shape and dimensioned to be received within the lower portion 3 of the case 1. The device tray 12 may be constructed from various materials, such as for example injection moulded plastic. The device tray 12 is located within the cavity 4 so as to position the mobile communications device (not shown) against an electronic connector (not shown). Furthermore, the device tray 12 is located within the cavity 4 so as to align the mobile communications device with the transparent plastic membrane 5 of the upper portion 2 of the case 1.

The case 1 further comprises an emergency button 13 operable to cause the mobile communications device (not shown) to emit an emergency response signal, preferably a radio response signal. The emergency button 13 is located within the case 1 so as to be in communication with the electronics package 100. The device tray 12 provides a recess 14 shaped and dimensioned to receive the emergency button 13. The emergency button 13 may be constructed from any suitable material, such as for example silicon and/or rubber material.

The case 1 further comprise an emergency button cover 15 in communication with the emergency button 14. The emergency button cover 15 is located so as to prevent accidental operation of the emergency button 14. The emergency button cover 15 may be constructed of either metal or plastic material. The case 1 further comprises an emergency button spring 16. The emergency button cover 15 may be resiliently biased by the spring 16 so as to hold the cover 15 closed until the cover 15 is removed or opened in order to access the button 14.

The case 1 further comprises a transparent end cap 20 located at an end portion of the case 1 extending between the first 7,7′ and second 9,10 of the upper and lower portion 2,3 of the case 1. The end cap 20 may be composed of any suitable material, such as for example injection moulded plastic. The end cap 20 provides a sealed environment around a module of LED lights (not shown) of the electronics package 100.

The lower portion 3 of the case 1 further comprises a power socket protection seal 21 located at the opposite end to the transparent end cap 20. The power socket protection seal 21 is a removable plug shaped and dimensioned to seal the connector and/or the recharging power jack (not shown) of the electronics package 100 against the dust and/or moisture in the external environment.

The case 1 further comprises an attachment point at an end for engaging lanyard 18 so that the user can carry the case (and the device) on their wrist or around their neck.

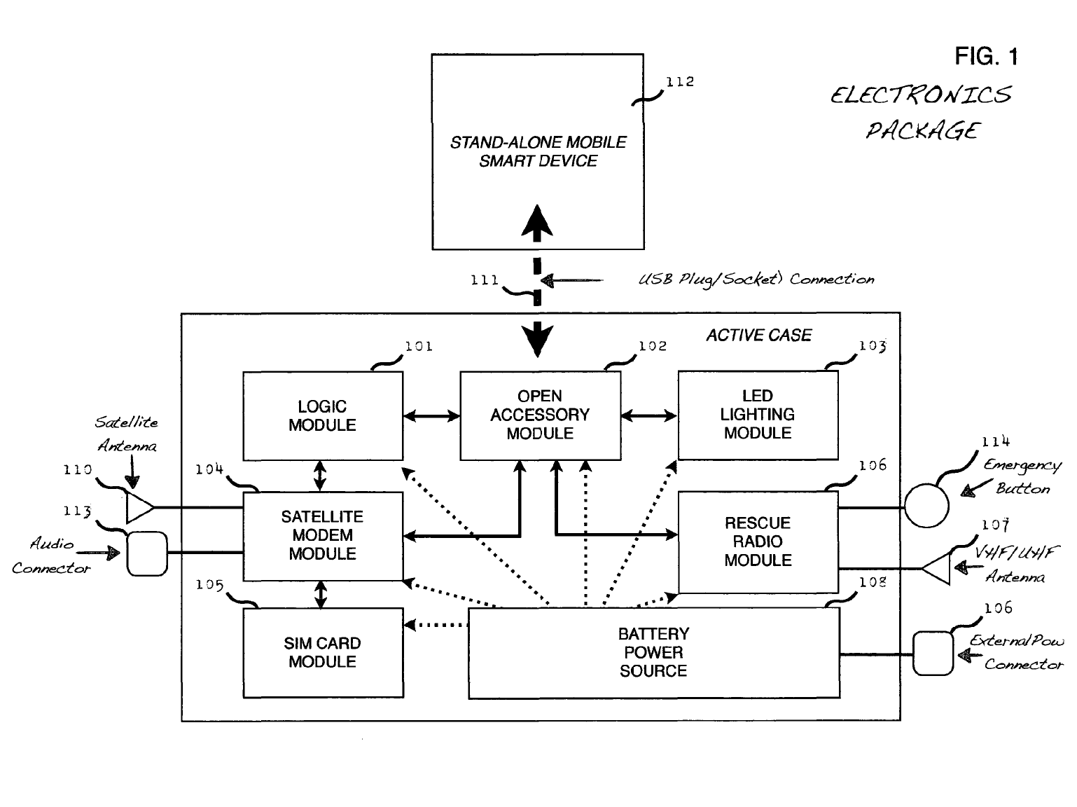

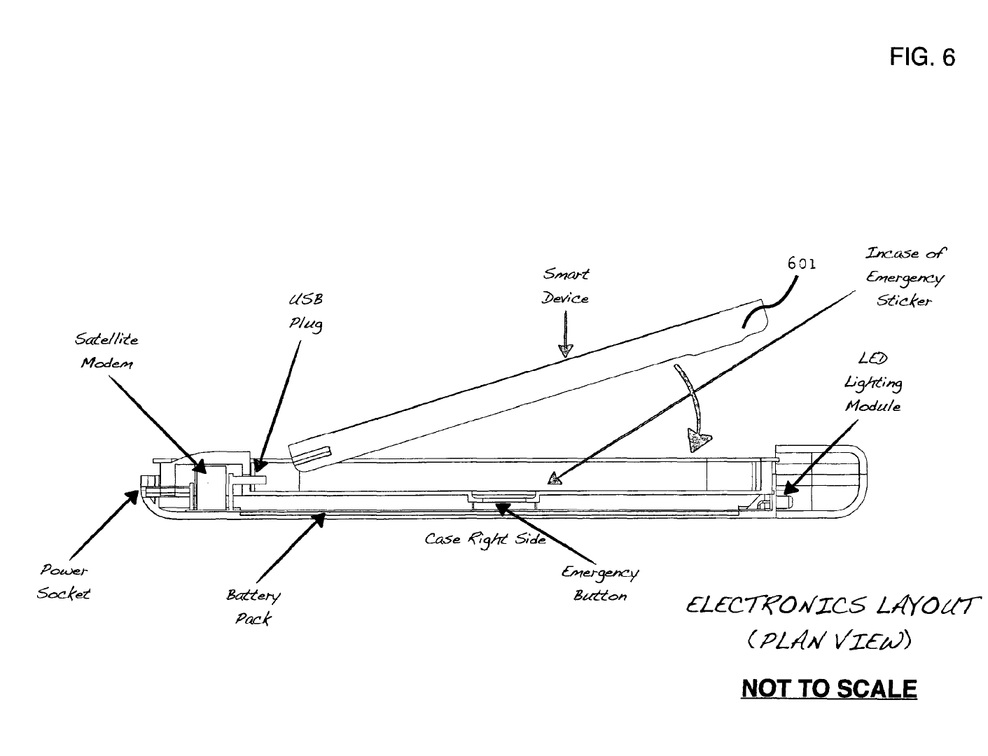

The case 1 further comprises an electronics package 100 as shown in FIGS. 1 and 6. The electronics package 100 contains a number of core component modules and/or off the shelf electronics hardware to integrate the electronics component with plugs, sockets and/or rechargeable battery packs. The electronics package 100 is located within the lower portion 3 of the case 1.

A number of core electronic modules and components are provided within the electronics package 100 located within the case 1. The electronics package 100 comprises:
Logic module 101: a number of integrated standard components used to manage electronic voltages and power requirements throughout the circuits;
Open accessory module 102: an integrated circuit such as the FT311D-32L manufactured by FTD, to enable the connection of an Android based device such as a smartphone or smartPad to another device such as our electronics package, via a USB wired connection allowing for bi-directional communication between the devices;
LED module 103: a package including off-the-shelf LEDs used for illumination and integrated into the circuit in such a way that they can remain static or blink/flash at various rates on demand when initiated by rescue radio circuitry;
Satellite modem module 104: a module, for example an Iridium 9523 modem, which can transmit and receive voice, video, data and short burst data (SBD) as well as providing GPS location information via for example the Iridium satellite network. The modem is integrated into the circuit in such a way that these functions can be used in their various modes. The modem may be connected via a 50Ω coaxial cable to an antenna 110 to support the transmit/receive functions;
SIM card module 105: An example includes the Amphenol C70710M0065002. This module may be integrated into the circuit as required to enable the Satellite modem module's, for example an Iridium modem's, various modes;
Rescue radio module 106: a VHF/UHF transmit/receive integrated circuit able to transmit/receive on at least one emergency radio frequency, such as for example 121.5, 156.8, 243 and 406 Mhz. The module may be connected to an antenna via a 50Ω coaxial cable 107. The rescue radio module 106 may be in communication with, for example integrated with, the emergency button;
VHF/UHF antenna 107: The antenna is preferably arranged to enable the transmit/receive functions on at least one emergency radio frequency, such as for example 121.5, 156.8, 243 and 406 Mhz for the rescue radio module 106;
Battery power source 108: may be any suitable source such as for example a lithium-ion battery, or other suitable re-chargeable battery. Preferably the battery source is capable of producing between 3.3 and 5.5 Volts in order to power the circuit and its various modules. The power source is preferably capable of being recharged via an external power source using a standard connector 109;
External power connector 109: This may be either a Centre Pin Power Socket with recharging power supplied by a suitable mains charger or a Micro/Min USB type socket providing power via a USB cable from a personal computer, laptop or other USB power source;
Satellite antenna 110: designed to enable the transmit/receive functions of the satellite modem module, for the TDMA/FDMA multi-plexing method, TDD Duplexing Method, in the frequency range of 1616-1626.5 MHz with an impedance of 50Ω;
USB/OTG connection 111: For example, a USB-AB Male type plug. The plug may be integrated into the circuit for connection by the USB-AB Female type socket in the stand alone mobile communications device, for example smart device 112;
Audio connector 113: The audio connector may be integrated with the Satellite modem module and the USB/OTG connection so as to provide audio output through to the mobile communications device and an external audio jack which may for example be housed within a transparent end cap 20.
The emergency button 13 is integrated with the rescue radio.

In order for the mobile communications device to be able to be used with the case 1 of the present invention, an android application may be required to be downloaded to the device. The case 1 is arranged such that once the device is received within cavity 4 and connected to the connector the android application is automatically downloaded to the device. A link to the application may be embedded in the open accessory module. The android application uses standard API's available to a developer via Google Android Software Development Kit (SDK) and are related to USB/Serial Communications and the Google Android Open Accessory Development Kit (ADK).

Suitable mobile communication devices, such as for example smart devices, for use with the case of the present invention include devices using the Android™ operating system version 2.4 with a Kernel of 2.6.32 and having a USB/Serial interface with full OTG support enabled. For example, the SAMSUNG Galaxy S3™ smartphone with the Google Android 4.04 operating system and Kernel 3.9.15 which has not been ROOTed.

In use, the user places the case 1 in the open configuration by disengaging hinged clips 8 from the lower portion 3 of the case 1. The mobile communications device, for example a smart phone, is placed within cavity 4. The mobile communications device is received within device tray 12. The device tray 12 positions the device so that the device is connected to the connector and so that the device is aligned with the transparent plastic membrane 5 of the upper portion 2. The case 1 is then moved to the closed configuration by engaging the upper 2 and lower 3 portions of the case 1. Hinged clips 8 are engaged with the lower portion of the case 1. Seal 11, located between the upper 2 and lower 3 portions of the case 1, provides a protective sealed environment around the cavity 4 of the case 1. Once received within the case 1 and connected to the connector the required android application is automatically downloaded to the device. The case 1 enables the mobile communications device to operate with mobile, wireless, cellular and satellite communications, with a rescue radio on board. The mobile communications device is protected from the external environment and the user may also use the device in areas where cellular communications are not available.

In an emergency, the user may open the case 1 and retrieve the device from cavity 4. The user may remove the emergency sticker 17 located within the lower portion 3 of the case 1. Removal of sticker 17 reveals, the emergency button cover 15. The user may then remove the button cover 15 and operate the emergency button 13 to operate a rescue radio beacon.

Although aspects of the invention have been described with reference to the embodiment shown in the accompanying drawings, it is to be understood that the invention is not limited to the precise embodiment shown and that various changes and modifications may be effected without further inventive skill and effort.

1. A case for releasably securing a mobile communications device in a sealed environment, in which the case is adapted to enable the device to operate with mobile, wireless, cellular and satellite communications.

2. A case as claimed in claim 1, in which the case comprises:
a connector coupled to a source of electrical power, in which the connector is arranged in use to be connected to the mobile communications device; and
a satellite modem arranged in use to be operable by the mobile communications device.

3. A case as claimed in claim 2, further comprising a rescue radio beacon coupled to the connector.

4. A case as claimed in claim 3, in which the rescue radio beacon is arranged in use to be operable by means of the mobile communications device.

5. A case as claimed in any one of claims 2 to 4, in which the rescue radio beacon is arranged in use to be operable independently of the mobile communications device.

6. A case as claimed in any preceding claim, in which the case is moveable between an open configuration providing an opening into a cavity for receiving a mobile communications device, and a closed configuration providing a sealed environment around the cavity for receiving the mobile communications device.

7. A case as claimed in any claim 6, further comprising a locking mechanism for retaining the case in the closed position.

8. A case as claimed in claim 7, in which the locking mechanism comprises at least one locking member selected from hinged clips or hooks.

9. A case as claimed in any one of claims 6 to 8, further comprising a seal arranged in the closed position to provide a sealed environment around the cavity for receiving the mobile communications device.

10. A case as claimed in claim 9, in which the seal is composed of silicon and/or flexible rubber material.

11. A case as claimed in any one of claims 6 to 10, in which the case comprises an upper portion and a lower portion which are arranged to releasably engage each other.

12. A case as claimed in claim 11, in which the upper and lower portions are hingeably engaged.

13. A case as claimed in either of claims 11 and 12, in which the upper portion comprises an engagement surface arranged to releasably engage a corresponding engagement surface provided by the lower portion and/or a seal, in which the engagement surfaces provide complementary engagement features for providing a seal between the upper and lower portions of the case.

14. A case as claimed in claim 13, in which the at least one engagement features are selected from raised ridges and complementary shaped recesses.

15. A case as claimed in any preceding claim, further comprising an electronics package comprising at least one electronic component.

16. A case as claimed in claim 15, in which the electronics package is located within the lower portion of the case.

17. A case as claimed in any preceding claim, further comprising a device tray shaped and dimensioned to receive and/or align the mobile communications device within the case.

18. A case as claimed in claim 17, in which the device tray is located within the cavity provided by the case so as to position the device against an electronic connector.

19. A case as claimed in any preceding claim, further comprising an emergency button operable to cause the mobile communications device to emit an emergency response signal.

20. A case as claimed in claim 19, in which the emergency button is located within the cavity provided by the case.

21. A case as claimed in either of claims 19 and 20, in which the response signal is a rescue radio response signal.

22. A case as claimed in any preceding claim, further comprising one or more electronic modules selected from: logic module; open accessory module; LED module; Satellite modem module; SIM card module; and/or rescue radio module.
